(19) United States
(12) Patent Application Publication
(10) Pub. No.: US 2005/0249221 A1
(43) Pub. Date: Nov. 10, 2005

(54) Method for the recursive and statistical analysis of communications networks

(75) Inventors: Frederic Remi, Cholet (FR); Cyril Tessereau, Cholet (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: THALES

(21) Appl. No.: 10/712,275

(22) Filed: Nov. 14, 2003

(30) Foreign Application Priority Data
Nov. 15, 2002 (FR) 02 14343

(51) Int. Cl. H04L 12/28

(52) U.S. Cl. 370/395.5; 709/231

(57) ABSTRACT

A method and device for the analysis of datastreams in a communications network modeled by several layers comprises the steps of capturing a datastream for a given network layer, analyzing the totality of the stream in order to determine the protocol or protocols present, producing different streams corresponding to at least one protocol present, and reiterating the step of analysis for a higher layer if any.

### BACKGROUND OF THE INVENTION

1. Field of the Invention

The invention relates to a method for the recognition and analysis of network communications, such as Ethernet, TCP/IP, etc.

The invention can be used, for example, for the implementation of integrated chains of acquisition, and analysis and information. It enables the real-time performance of all the functions complementary to the active and passive monitoring of a network:
profiling of communications, networks and users;
assistance in datamining (or semantic extraction, indexing and exploration) in a network;
assistance in monitoring (checking and auditing) and intruder detection.

It can be applied especially to the monitoring of secured streams.

2. Description of the Prior Art

As a rule, a network surveillance system uses an analyzer for the extraction, from the stream of frames being monitored, of certain significant pieces of information on users sending and receiving the stream. The obvious and known approach for this operation is to assume that this stream complies with one of the existing network models. Each frame is then isolated and the analyzer then makes a systematic trace-back through the layers. While this method offers a certain degree of simplicity, it nevertheless has certain limits. These limits are especially:
the impossibility of analyzing streams that contain protocols not compliant with standards or norms;
the non-restitution of the streams since the analysis of each frame is taken independently.

The functions of the existing products, such as network analyses including, for example, Ethereal (Ethereal is the name of a freeware program under GPL public licence) and Surveyor (registered trademark belonging to the firm Shomiti), are limited to the simple identification of isolated packets traveling through the network. While they prove to the efficient, they do not take account of the stream concept (the reading of fields, without managing the behavior of the application in data transmission/reception or the dissemination of information between several packets in most cases). Consequently, access to the contents, namely access to the data of the user transmitted in the stream by applications using the IP protocol, is limited.

Furthermore, the existing products analyze packets in the same way as standard protocol stacks. They therefore have no capacity of adaptation to non-standard situations. Nor do they possess any “intelligence” in processing. The automatons do not have any capacity for synthesizing or consolidating information. This function is left to the user application, i.e. above the level of the protocols. In the context of the present description, the term “non-standard” refers to specific applications using modified versions of protocols that remain routable on the IP (Internet Protocol) networks but are not interoperable with other applications.

### SUMMARY OF THE INVENTION

The invention proposes a novel approach that relies especially on a total analysis of the streams (streams of data frames exchanged in a network).

To this end, it enables an analysis of communications in a network at the level of entire streams, in implementing especially the following principles:
widthwise layer-by-layer analysis, for example in the TCP/IP model and not packet-by-packet analysis;
statistical characterization of the streams, including a semantic analysis of the protocol variants and a behavioral analysis of the dynamics of the exchanges.

The invention relates to a method for the analysis of data streams in a communications network modeled by several layers. The method comprises at least the following steps:
capturing a datastream,
for a given network layer, analyzing the totality of the stream in order to determine the protocol or protocols present,
producing different streams corresponding to at least one protocol present,
reiterating the step of analysis for a higher layer if any.

The method comprises, for example, the following steps:
1) analyzing the captured packet,
   1.a) if the packet is not recognized, passing to the next packet,
   1.b) if the packet is recognized, eliminating the packet from the captured stream, searching for an existing stream in order to insert the packet,
      if there is no existing stream, generating a new stream,
2) analyzing the streams generated at the step 1),
3) releasing the resources.

The total analysis of the streams is done, for example, by means of statistical or protocol analysis tests.

The method can be applied to the analysis of data in a network having the TCP/IP protocol.

The invention also relates to a device for the analysis of data streams in a communications network capable of being modeled in several layers, the device comprising at least one processor adapted to implementing the method as described here above.

Advantages

The invention has especially the following advantages:
it adapts to different IP stream structures, both standard and non-standard, with discrimination between secured streams and unprotected streams at all levels of the stack (clear/enciphered recognition),
it enables the search for cryptographic information for which algorithmic type recognition provides services of confidentiality and integrity (for block encryption standards, such as the AES or Advanced Encryption Standard, the DES or Data Encryption Standard, for hashing function standards such as the SHA or Secure Hash Algorithm and the MD5 of Message Digest 5),
it produces unified audit reports directly exploitable by an administrator of security officer. These reports are given, for example, by summarizing the rules generated for the streams and packets, presented as a synthesis in a format readable by an operator and capable of being filtered, as the case need be, as a function of certain criteria of display.

It provides:
open-ended identification: the possibility of adapting to the recognition of non-standard protocols (analysis of structures),
an open architecture: on-site enhancement of the tool by the addition of components dedicated to new protocol or a new method of analysis,
the capacity to analyze streams containing protocols only partially compliant with standards or norms, or protocol systems using forms of structuring in specific layers, the orientation of the analysis towards streams and not frames, making it possible to obtain information on automatons linked to protocols and applications behavior,
each processing step is independent of past and future steps, making it possible to take account of all types of protocols with the possibility of packaging that is independent of the complexity of the network stream analyzed.

### BRIEF DESCRIPTION OF THE DRAWINGS

Other characteristics and advantages of the invention shall appear more clearly from the following description of an exemplary non-restrictive embodiment and from the appended figures of which:

FIG. 1 exemplifies a protocol tree implemented for the invention,

FIG. 2 exemplifies a simplified model of the processing architecture,

FIG. 3 is a sequence diagram pertaining to the sorting of the packets,

FIG. 4 is an exemplary result obtained by the implementation of the method according to the invention.

### MORE DETAILED DESCRIPTION

The idea implemented in the method according to the invention relies especially on the use of semantic and statistical recognition methods to characterize protocols of the TCP/IP (Transmission Control Protocol/internet Protocol) stack.

The invention is characterized by the following novel approach. In the case of normal operation, no assumption is made on the layered structure of the frames. On the contrary, this structure is deduced, for example, from an analysis of the frames in search of representative patterns described in protocol signatures. Thus, the invention analyses the totality of the stream in seeking to determine the lowest-level (for example the physical level) protocol or protocols present. The stream is then separated as a function of the protocols identified, and the analysis is reiterated for another layer if any. As and when the structuring in layers is recovered, the stream as a whole is verified and subdivided as a function of the recognized layers.

For a clearer understanding of the steps of the method according to the invention, the example given relates to the analysis of data streams in the context of the TCP/IP protocol, within an adapted analyzer comprising a processor programmed to execute the steps of the method. This example is given as an illustration that in no way restricts the scope of the invention.

General Model of the Processing Operations

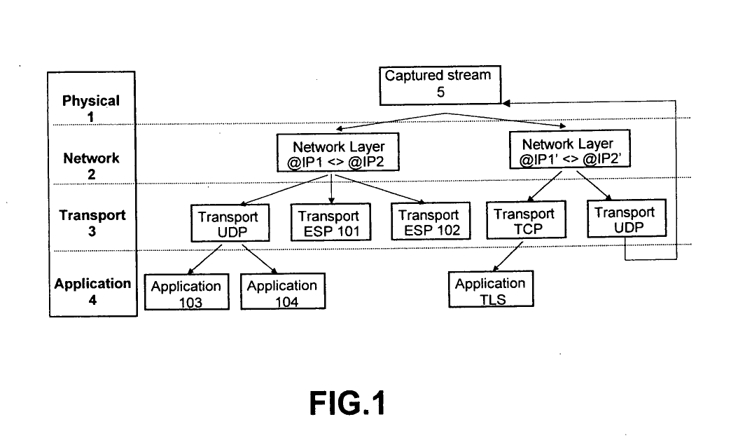

FIG. 1 is a schematic view of an exemplary protocol tree according to the invention representing the streams analyzed. The steps of the method consist especially in:
building a protocol tree representing the analyzed streams; a node of the tree corresponds to the characteristic parameters of an analyzed stream and a branch corresponds to the representation of the processed streams,
carrying out to widthwise scan of the tree for the extraction therefrom of the relevant information, namely the identification of the frames (IP addresses), services provided by the network layer (IP routing option, for example in order to ask the network for a specific routing rather than allow the routers themselves to decide the path to be taken), special or unusual events (the renewal of an encryption key, a break in a stream, a replayed attack on an encrypted stream); in other words the extraction of relevant information on the contents of the rules.

The steps of the protocol tree correspond for example to the network layers of the TCP/IP stack: the physical layer 1, the network layer 2, the transport layer 3, and the applications layer 4. The root 5 of the protocol tree corresponds to the level at which the stream capture is made. For example, in the case of an Ethernet stream, the root is at the physical level (physical level 1).

In a network stream, the information is conveyed in elementary structures called “frames”. These frames are sent one by one on the physical link, each independently. Depending on the medium used for the flow of information, the frame may be preceded by silences and/or synchronization preambles: these signals linked to the medium exist for signal-processing considerations. In network terminology, a block of transferred information takes a different name depending on the OSI layer that handles it: at the physical level it is called a “frame” and, at the network level it is called a “packet” or “datagram”. The transport level handles “segments” and, at the applications level, the units considered are “messages”. The terms “frame” and “packets” designate a same data entity.

The streams considered by the method according to the invention are, for example, sequences of frames cleansed of the signals related to the medium.

A datastream is divided into:
a variable number of packets (each packet represents a network frame),
a variable number of rules (initially there are no rules, and they are created by the analysis engine as described here below).

Each frame has an internal structure that corresponds to a stratified system: the networks are based on layered models. The two currently existing models of layers are the standardized OSI model of the ISO and the TCP/IP system of standardized protocols. The principle of a layered model is that of subdividing all the transmission/reception operations into several modules representing a layer, each having a precise role. These modules execute their specific tasks in sequence.

The data or information packets flowing in the networks are processed successively by each layer, in a fixed order. Each layer of the model has a specific level of abstraction (for example: physical link, transport stream, application session etc) and communicates with layers of adjacent levels of abstraction. This corresponds to the notion of a “lower” layer and an “upper” layer. Each layer thus uses the services of the lower layers and gives information to the upper-level layer.

| Layer | Level of abstraction | Function |
|---|---|---|
| 1 | Physical | defines the way in which the data are |
| | | converted into electrical, optical and other |
| | | signals |
| 2 | network | enables the localizing of a machine in a |
| | | network and the managing of the routing |
| | | between two machines |
| 3 | transport | carries out the transportation of data |
| | | between a customer application and a |
| | | server application |
| 4 | Application | sets up the interface with the applications |

The information to be exchanged by the network is, for example, a piece of applications data, namely a piece of unprocessed information from the user (a file stored on a floppy, the text of an electronic mail, sound and video information, of a videoconference etc). This information is processed successively by all the layers of the model from the applications level (layer 4 in the above example) to the physical level (layer 1). While it is being processed, each layer of the sender of the frame produces information intended for the corresponding layer of the receiver (for example information on transfer error detection, acknowledgements of reception etc).

When it is sent, this information is assembled in a structured block known as a “header” according to a given protocol. This header is added to the data block received at the upper level, and then the whole set is transmitted to the lower level.

At reception, the header is extracted from the data block received from the lower level and is consumed, i.e. used by the current level to determine the service to be provided (in other words: to know how to process the contents of the block and the service to which it must be given thereafter). Finally, the header is destroyed and the remaining information (the data of the block without header) is transmitted to the upper level for processing.

In this way, a frame is a succession of protocol headers, each being followed by the “user” applications data.

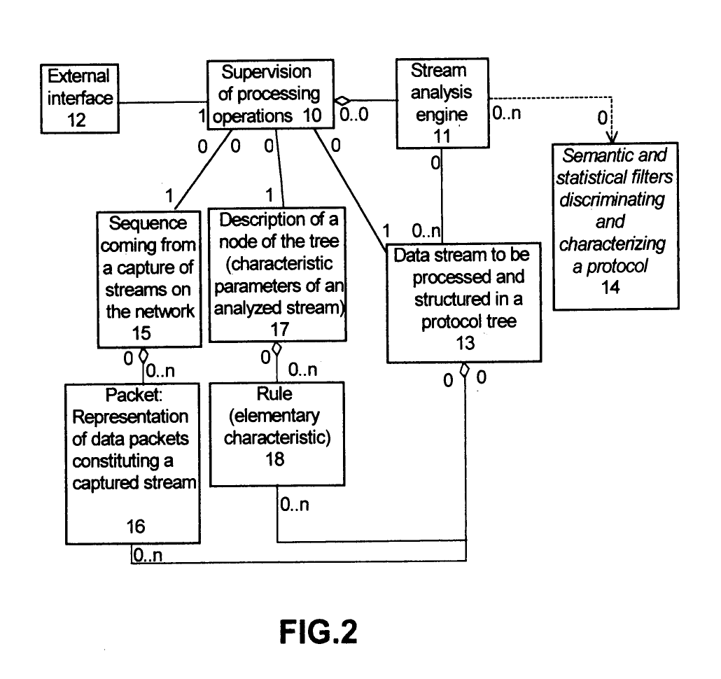

FIG. 2 is a simplified model of an exemplary stream-processing architecture according to the invention. The conventions used in this FIG. 2 come from the UML (Unified Modeling Language) model. The UML model is standardized and published by a group known as the OMG (Object Management Group).

The method according to the invention or application is shared between a supervision process 10 and a stream analysis engine 11 that distributes the processing operations.

The supervision process 10 is controlled by the operating environment through an external interface 12. This process 10 processes a stream, taken from the list of captured streams and concretely expressed by the link 10 [symbol] 13. It constitutes a representation thereof through:
A sequence of packets 15 coming from the packets 16 of the stream 13. By definition, 13 is a list of packets 16. When the packets are eliminated from a stream, the supervisor keeps them in a sequence 15 pending their insertion into a new stream.
A protocol tree that positions the streams with respect to each other by means of the relationships between the corresponding nodes 17 of the tree. Each node furthermore points to the rules 18 of the stream 13. The link between 10 and 17 represents the link enabling the supervisor to move in the tree. It is initially the link between the supervisor and the root, and as and when new nodes are created, the supervisor moves. The link between 17 and 18 enables the rules to be attached to a stream. The contents of the rules are, for example, a sequence of pairs {name=value} such as for example “source address=d,C0A80001” (a detailed example is given at the end of the description). These pairs are given by the signing of the protocol: each is the result of the application of a “test” or dedicated “filter”, the collection of all the filters and their sequencing order forming the signature. For example here, in the signature of the IP protocol, there is an ‘address_source’ filter which, applied to a packet, sends back the above message.

At a given point in time, the stream analysis engine 11 reads a file 13 of streams coming from the supervision and may create a variable number of them. They are added to the list of the streams handled. The stream analysis engine may load the memory dynamically with a variable number of filters 14 (for example in the form of DLLs, or Dynamic Link Libraries) enabling it to process the stream considered. The filters are, for example, semantic and statistical filters discriminating and characterizing a protocol.

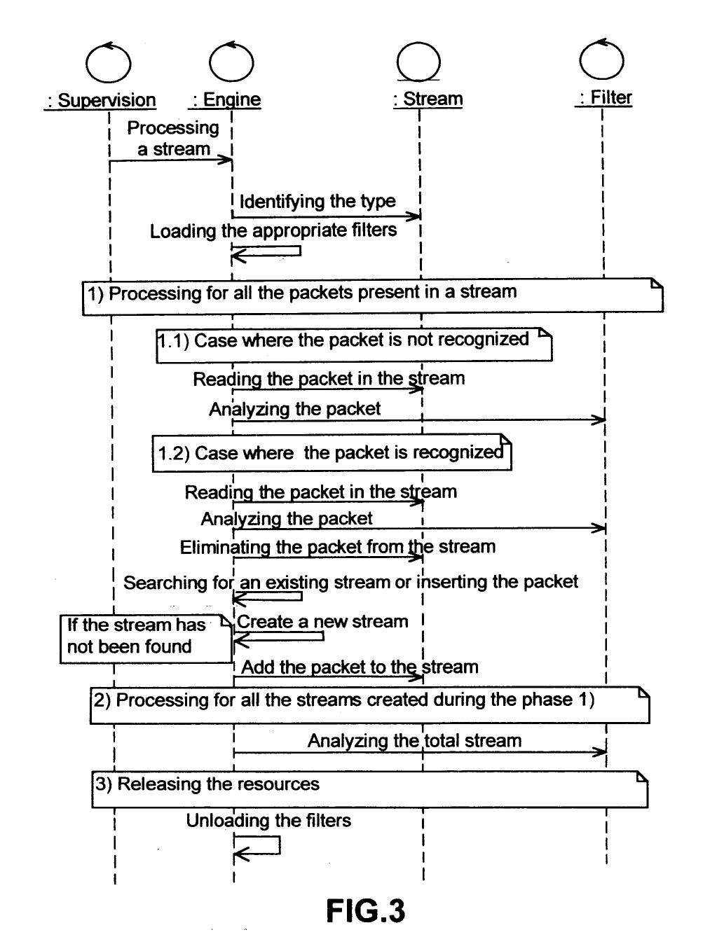

FIG. 3 is an exemplary sequence diagram on the sorting of the packets contained in the frames conveyed by the medium. This sorting is done by the process known as the ‘engine’ process,
which accepts the following as parameters:
   a network stream capture file comprising, for example, a sequence of IP packets,
   a processing level (level of the TCP/IP model to be processed); this piece of information is given by the operator. For example the MMI (Man/Machine Interface) asks the operator for the name of the capture file and then proposes a list of levels to this operator from which he makes a choice,
   a protocol tree that is initially vacant, i.e. reduced to a root located at the selected processing level. In other words, the system is initialized by giving it a root defined as a function of the previously chosen layer number. And
gives the full tree at output, namely the tree matched with new branches representing the processed streams.

In the graph of FIG. 3 the different steps of the method used to construct the new branches of the tree may be summarized, for example, as follows:

0—the supervisor sends a command for the processing of a captured stream,

Phase 1

1—the engine reads the packet, analyses the packet by means of the loaded filters and then takes the following steps depending on the result of the filters (“recognized” or “not recognized” decision),
1a—If the packet is not recognized, the engine goes to the next packet,
1b—if the packet is recognized, the engine eliminates the packet from the stream and searches for an existing stream in order to insert the recognized packet. If the engine does not find an existing stream, then it generates a new stream into which it inserts the packet. Finally, the engine goes to the next packet.

A packet is tested for each protocol (hence for each signature, i.e. a set of filters) until a “recognized” decision is obtained. For example, at the transport layer, if UDP (User Datagram Protocol) filters and then TCP (Transmission Control Protocol) filters are loaded, the UDP filters will be applied first to the packet. If the response is a “recognized” decision, it is put into an appropriate stream, and the operation passes to the next packet. If it is ‘non-recognized’, the operation is started again with the TCP filters.

If the TCP filter replies with ‘non-recognized’, the packet remains in the stream and the operation passes to the next packet.

Phase 2=at the end of phase 1, the method possesses a set of streams that are totally analyzed by means of the loaded filters. The different streams form the different branches of the tree.

After the step 1 is performed, the original stream is reduced, all the recognized packets having been extracted and shifted into (or assembled in) other streams. All that remain are non-recognized packets, or even no packets at all. We there have a ‘reduced’ original stream and a series of new ‘daughter’ streams. The streams are said to be ‘grouped together’.

Phase 3=the releasing of the resources—the filters are all unloaded and all the memory that they could have used is released.

There are for example two types of filters, filters in packet mode and filters in stream mode. The former are used to state whether the packet is ‘recognized’ or ‘non-recognized’ for the protocol and enable an identifier to be given (briefly, relative to the example given at the end: the name used to rename the stream and the file recorded on the floppy, such as for example: “IP_C0A80001_C0A80064, UDP_{—}01F4_{—}01F4”). In stream mode, additional information will be given (new pairs are added to the rule). For example, it is in this stream mode that the filter will be able to say that ‘TOS=0’ and that another filter will be able to establish the fact that ‘options IP=absent’.

In a first operation, cf. phase 1) of the sequence diagram, the engine uses explicit information on each datagram taken independently (identification relying on semantic protocol signatures, called: ‘packet filters’). It makes no cross-referencing, no statistical analysis and no in-depth processing on the nature of the datagrams but carries out the tasks of reassembling the IP fragments/TCP segments.

When a stream is put together by the'engine'process', as is the case with each of the streams of the set obtained in 2), this stream carries out a total analysis in a second operation, cf. phase 2) of the sequence diagram, using statistical or protocol analysis tests (‘stream filters’) discriminating the useful parameters of the protocol considered in the context of the full stream.

Finally, the'engine' process cleanses the tree by collecting and then eliminating the list of datagrams corresponding to unambiguously identified protocols. The list of collected data, corresponding to the packets that have been recognized, are given at output with their characteristics. The datagrams of non-identified branches are exported as such (for analysis, if necessary, with another compatible tool or after adding to the signature base).

Detailed Processing Operations

To determine the protocol relative to a network layer, the invention exploits a base of protocol signatures. A signature is a collection of filters, some working by ‘packets’ (they process only one packet at a time) and some working by ‘streams’ (they need all the packets simultaneously). The signatures comprise a set of tests with a threefold goal:
determining whether a frame uses the signed protocol for the analyzed layer (yes/no verdict);
determining significant information pertaining to the recognized protocol for the frame (as the identification of the sender or recipient, the use of certain modes or options etc). This information is gathered together in a rule associated with the packet;
determining significant information pertaining to the protocol for the stream (for example breaks in sequence not compliant with standard automaton etc.). This information is gathered together in a rule associated with the stream;

Since the processing of a stream is broken down into layers, it is recursive, and each step of the recursivity comprises the following operations (cf. FIG. 3):
retrieving the list of the protocols liable to appear at the level considered;
carrying out a frame-by-frame analysis of the stream, where each frame is confronted sequentially with all the protocol signatures envisaged until a positive verdict is declared;
retrieving the rules by packet of each frame recognized;
classifying the frames as a function of the rules: all the frames having the same protocol and the same rule per packet are shifted into a distinct stream (any remaining streams are concentrated in a ‘non-recognized’ stream);
carrying out a total analysis of each of the streams thus extracted relative to its recognized protocol, and then associating the stream rule coming from the analysis.

It can be seen that, for an incoming stream, several outgoing streams can be generated by the invention: the parental relationship between the incoming stream and the outgoing stream or streams is recorded in the form of a tree.

Illustration of the Principle of the Invention on an Example

It is assumed that a capture stream C contains three frames: two coming from the TCP/IP protocol system for a non-signed application; and one frame coming from a non-IP model. This stream is produced and recorded in the following form:
frame 1=IP(a→b)/TCP(s→d)/?
frame 2=IP(a→b)/TCP(s→e)/?
frame 3=?

Where the following convention of representation is used:
the protocols are listed from left to right from the lowest level to the highest level;
the protocol signed P specifying the sending of data from its source S to the destination D is referenced P(S→D)
a non-recognized protocol is written as ?

It is also assumed in the example that the invention is instrumented by the following protocols:
Layer 2 network: IP;
Layer 3 transport: UDP, TCP;
Layer 1 application: HTTP.

It is specified that the first protocol assumed to be present is a network protocol.

Initially, the method according to the invention considers the stream C as:
frame 1=?
frame 2=?

The engine loads the signature of the IP protocol and applies to the frame 1.

The verdict is positive and the associated rule is: IPsource=a, IPdestination=b.

A new stream IPab is created: the frame 1 is eliminated from the stream C and shifted into the stream IPab.

Then the frame 2 is confronted with the signature of IP. The verdict is positive and the association rule is: IPsource=a, IPdestination=b.

Since the stream IPab for IP associated with this rule exists, the frame 2 is shifted therein.

Finally, the frame 3 is confronted with the signature of IP. The verdict is negative. However the invention does not possess other signatures. Hence the frame 3 is left as being non-recognized at the network level.

With all the frames being processed, the invention performs the analysis of the streams created: the stream IPab is confronted with the signature of IP. The result is a stream rule: ‘TTL=64, options=none’.

At the end of this step, there are therefore two streams:
IPab(IP:TTL=64, options=none):
frame 1=IP(a→b)/?
frame 2=IP(a→b)/?
C:
frame 3=?

The streams are recorded as daughters of the stream C.

Since UDP and TCP are liable to appear at a level higher than IP, the invention proceeds to a new processing step:

The invention is responsible for loading the signature of the UDP and TCP protocols.

The invention applies the UDP signature to the frame 1.

The verdict is negative: therefore the signature of TCP is applied.

The verdict is positive and the associated rule is: TCPsource=s, TCPdestination=d.

The new stream IPab,TCPsd is created: the frame 1 is eliminated from the stream IPab and shifted into the stream IPab,TCPsd.

The method applies the signature UDP to the frame 2.

The negative verdict, hence the signature of TCP, is applied.

The verdict is positive and the associated rule is: TCPsource=s,TCPdestination=e.

Since the existing stream IPab,TCPsd is not suitable, a stream IPab,TCPse is created: the frame 1 is eliminated from the stream IPab and shifted into the stream IPab,TCPse.

The stream IPab,TCPsd is confronted with the signature of TCP. The result is a vacant stream rule. Similarly for IPab,TCPse.

At the end of this step, there are therefore three streams:
IPab,TCPsd(IP:TTL=64,options=none;TCP:vacant):
frame1=IP(a→b)/TCP(s→d)/?
IPab,TCPse(IP:TTL=64,options=none;TCP:vacant)
frame1=IP(a→b)/TCP(s→e)/?
C:
   frame3=?

The streams IPab,TCPsd and IPab,TCPse are recorded as daughters of the stream IPab.

The frames of IPab having been entirely consumed, IPab disappears as a stream. However, the corresponding node is kept in the tree with its stream rule.

The invention carries out a last processing step for the two streams that have just been created. In the same way as for the stream 3, the confrontation with the signature of HTTP fails and the streams are left unchanged.

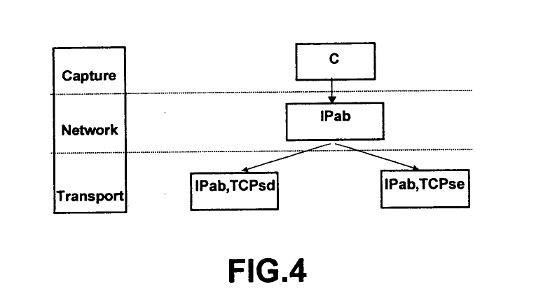

Since all the existing streams have been completely processed, the previous list constitutes a final result of the analysis and the associated protocol tree is illustrated in FIG. 4.

### Alternative Embodiment

The invention described for the TCP/IP, whose specific terminology is adopted here, can also be adapted to the OSI model because the two models have strong similarities due to a partially common preparation.

For example, the layers of the most complete model are described in detail: this is the OSI model.

| Layer | Level of abstraction | Function |
|---|---|---|
| 1 | physical | defines the way in which the data are |
| | | converted into electrical, optical and other |
| | | signals |
| 2 | data link | defines the interface with the network card |
| | | and enables the identification of one |
| | | network card among several connected to a |
| | | same link |
| 3 | network | enables the localizing of a machine in a |
| | | network and the managing of the routing |
| | | between two machines. |
| 4 | transport | carries out the transportation of data |
| | | between a customer application and a |
| | | server application |
| 5 | session | defines the opening of the sessions of the |
| | | customers on a server |
| 6 | Presentation | defines the data format (their |
| | | representation) |
| 7 | Application | sets up the interface with the applications |

The method according to the invention offers new methods of communications analysis. These methods include:
The recursive recognition and discrimination of protocols of the TCP/IP stack, including the tracing back of all types of tunnelling;
The statistical recognition of the characteristics of the protocols of the TCP/IP stack and statistical discrimination between variants of protocols. The invention especially enables discrimination between the standard of security for IP ESP as specific forms of implementation (ex: the THALES Mistral IP encryptor).
The possibility of being implemented in different communications networks that can be modeled by layer.

A concrete example is given here below in order to explain the rule concept used in the present description. The choices of implementation are not exclusive with respect to the invention. They must therefore be taken purely as an indication given in order to provide an improved understanding of the invention.

At input, an ‘UDP/IP’ type stream has been analyzed. This is an IP communication sending messages through the UDP transport protocol. The application is used to manage the parameters of security for IPSec (for example, arriving at a mutual agreement on an encryption key). This application and the protocol that conveys it are both called ISAKMP.

The analysis 11 has initially recognized an IP stream 13 IP (the lowest protocol level available in the signatures, cf. 14) and extracted a rule 18 whose label is as follows:
“IP_C0A80001_C0A80064: Source Address=d,C0A80001|Destination Address=d,C0A80064|TOS=p,0|Options IP=p,absent”.

(It will be noted that the format is practically readable as such, provided that the hexadecimal conversions are made and that a few conventions internal to the rules are known).

This being done, the stream is re-analyzed at the transport level, and an UDP stream is discovered. A new rule 18 is then created for the UDP stage: “UDP_{—}01 F4_{—}01F4: Port Source=d,01F4|Port Destination=d,01F4”

In the present case, the signature (filters 14) that would have enabled the addition of a special rule to ISAKMP has not been included: therefore there is no additional work to be done on the stream and the analysis 11 stops there.

From these two rules, the stream is renamed:
“IP_C0A80001_C0A80064,UDP_{—}01F4_{—}01F4”

This identifier is used to localized it in the protocol tree (label of the node 17) and to manipulate it in the form of files (through the Windows explorer, it is possible to find a file bearing this name and containing the frames of this stream)

When the prototype has finished its analysis, it displays a synthesis to the operator (presently in HTML) for the stream:
IP_C0A80001_C0A80064,UDP_{—}01F4_{—}01F4:
   IP

Definition:
Source Address: 192.168.0.1
Destination Address: 192.168.0.100

Packetwise Rule
TOS: 0
Options IP: absent
   UDP

Definition
Source Port: 500, Internet Security Association and Key Management Protocol (ISAKMP)
Destination Port: 500, Internet Security Association and Key Management Protocol (ISAKMP)

It will be noted that the information displayed literally corresponds to the contents of the rule. The display gives these “unprocessed” contents the comfortable appearance of a table with a few convenient features for reading (such as the conversion of IP addresses from hexadecimal notation or the explicit name of the recognized ISAKMP protocol).

The invention also relates to a network analyzer comprising at least one processor adapted to the execution of the different steps of the method described here above.

1. A method of analyzing of data streams in a communications network modeled by several layers, the method comprising the following steps:
capturing a datastream;
for a given network layer, analyzing the totality of the stream in order to determine the protocol or protocols present;
producing different streams corresponding to at least one protocol present; and
reiterating said analyzing step for a higher layer if any.

2. The method according to claim 1, comprising the following steps:
1) analyzing the captured packet:
1.a) if the packet is not recognized, passing to the next packet;
1.b) if the packet is recognized, eliminating the packet from the captured stream, searching for an existing stream in order to insert the packet, and if there is no existing stream, generating a new stream,
2) analyzing the streams generated at the step 1);
3) releasing the resources.

3. The method according to claim 1 comprising, further comprising:
retrieving a list of the protocols liable to appear at the level considered;
carrying out a frame-by-frame analysis of the stream in making a frame sequentially confront all the protocol signatures envisaged so long as the frame is not associated with a signature;
retrieving the rule by packet of each frame recognized;
classifying the frames as a function of the rules and positioning them in distinct streams;
carrying out a total analysis of the distinct streams in using the recognized protocol or protocols;
associating the stream rule coming from the analysis.

4. The method according to claim 1, wherein the total analysis of the streams is made by means of tests of statistical or protocol analysis.

5. The use of the method according to claim 1, in the analysis of data in a network having the TCP/IP protocol.

6. The device for the analysis of data streams in a communications network capable of being modeled in several layers, the device comprising at least one processor adapted to implement the method comprising the following steps:
capturing a datastream,
for a given network layer, analyzing the totality of the stream in order to determine the protocol or protocols present;
producing different streams corresponding to at least one protocol present;
reiterating the step of analysis for a higher layer if any.

7. The device according to claim 6, wherein the processor is adapted to:
1) analyze the captured packet;
1.a) if the packet is not recognized, passing to the next packet;
1.b) if the packet is recognized, eliminating the packet from the captured stream, searching for an existing stream in order to insert the packet, and if there is no existing stream, generating a new stream;
2) analyzing the streams generated at the step 1)′
3) releasing the resources.

8. The device according to claim 6, wherein the processor is adapted to:
retrieve the list of the protocols liable to appear at the level considered;
carry out a frame-by-frame analysis of the stream in making a frame sequentially confront all the protocol signatures envisaged so long as the frame is not associated with a signature;
retrieve the rule by packet of each frame recognized;
classify the frames as a function of the rules and positioning them in distinct streams;
carry out a total analysis of the distinct streams in using the recognized protocol or protocols;
associate the stream rule coming from the analysis.

9. The device according to claim 6, wherein the total analysis of the streams is made by means of tests of statistical or protocol analysis.

10. The method according to claim 2, wherein the total analysis of the streams is made by means of tests of statistical or protocol analysis.

11. The method according to claim 3, wherein the total analysis of the streams is made by means of tests of statistical or protocol analysis.

12. A device for the analysis of data streams in communications network capable of being modeled in several layers, the device comprising at least one processor adapted in implementing the method comprising:
capturing a means for capturing a datastream;
analyzing means for analyzing for a given network layer, the totality of the stream in order to determine the protocol or protocols present;
producing means for producing different streams corresponding to at least one protocol present;
reiterating the step of analysis for a higher layer if any.

13. The device according to claim 12, further comprising:
1) analyze means for analyzing the capture packet;
1.a) if the packet is not recognized, passing means for passing to the next packet;
1.b) if the packet is recognized, eliminating means for eliminating the packet from the captured stream, searching for an existing stream in order to insert the packet, and if there is no existing stream, generating a new stream;
2) analyze means for analyzing the streams generated at the step 1);
3) release means for releasing the resources.

14. The device according to claim 6, further comprising:
retrieving means for retrieving the list of protocols liable to appear at the level considered;
carrying means for carrying out a frame-by-frame analysis of the stream in making a frame sequentially confront all the protocol signatures envisaged so long as the frame is not associated with a signature;
second retrieving means for retrieving the rule by packet of each frame recognized;
classifying means for classifying the frames as a function of the rules and positionint them in distinct streams;
second carrying means for carrying out a total analysis of the distinct streams in using the recognized protocol or protocols;
associating means for associating the stream rule coming from the analysis.

15. The device according to claim 14, wherein the total anlaysis of the streams is made by means of tests of statistical or protocol analysis.
